(19) United States
(12) Patent Application Publication
(10) Pub. No.: US 2011/0245400 A1
(43) Pub. Date: Oct. 6, 2011

(54) STIMULUS-RESPONSIVE POLYMERIC PARTICLES

(76) Inventors: Trevor John Wear, Swavesey (GB); John Martin Higgins, Pinner (GB); Andrew Clarke, Haslingfield (GB); Andrew Michael Howe, Cambridge (GB); Danuta Gibson, Reach (GB); Stephanie Veronique Desrousseaux, Arbonne (FR)

(21) Appl. No.: 13/080,908

(22) Filed: Apr. 6, 2011

(30) Foreign Application Priority Data
Apr. 6, 2010 (GB) 1005652.1

(51) Int. Cl. C08L 33/26; C08L 51/06; C08L 41/00; C08L 39/04; C08F 2/24; C09D 11/10

(52) U.S. Cl. 524/458; 524/829; 524/817; 524/808; 524/828; 524/745

(57) ABSTRACT

A stimulus-responsive polymer particulate composition, comprising a first monomer, such as an aqueous microgel derived, for example, from N-isopropylacrylamide, may be rendered less susceptible to aggregation at high shear (e.g. at least as high as 10⁶ s⁻¹) by incorporating into the structure of the particle (e.g. by copolymerisation) of a further monomer, which is not a stimulus-responsive polymer-forming monomer. The further monomer may be incorporated in an amount of up to 25 mol % based on the amount of the first monomer. Such modified polymer particles are suitable for inkjet printing applications (e.g. for printing of aqueous microgels onto low-energy surface substrates).

### CROSS-REFERENCE TO RELATED APPLICATIONS

The present application claims priority of GB Application Number 1005652.1, filed Apr. 6, 2010, by Trevor J. Wear, et al., and entitled, “STIMULUS-RESPONSIVE POLYMERIC PARTICLES.”

### FIELD OF THE INVENTION

The present invention relates to a method of preparing a polymeric compound comprising discrete particles that are responsive to an external stimulus, especially thermal stimulus, and are resistant to aggregation in high-shear fields, to the polymeric compound obtainable by the process and its use in an aqueous composition, for example, in inkjet printing systems for reducing or preventing such aggregation. The method comprises the incorporation of a secondary monomer component into the primary structure of a responsive polymeric particle to reduce or prevent the aggregation.

### BACKGROUND OF THE INVENTION

Cross-linked, water-swellable, stimulus-responsive particles, such as “microgels”, have been the subject of extensive studies that take advantage of the switchable properties of such materials. The unique feature of these hydrophilic “microgels” is that swelling with water and all related properties are very sensitive to an external stimulus, such as temperature. For example, the particle volume can typically decrease by a factor of ten when the temperature is changed from typical room temperature to 40° C. and the particle nature changes from being highly hydrophilic to highly hydrophobic. This latter property switch is particularly pertinent because the stability of aqueous, hydrophobic particle dispersions is much worse than that of aqueous hydrophilic dispersions.

The synthesis used to make such materials is a typical emulsion polymerization reaction, wherein the required monomer is reacted with a cross-linking agent, and optionally a surfactant, in an aqueous solution from which oxygen has been purged, with stirring. After heating, polymerization is initiated by addition of a polymerization initiator. The formed polymer is insoluble in the reaction medium and forms particles. The mixture is stirred, in the absence of oxygen to the required temperature for a number of hours, typically about 5 hours, until the polymerization is complete, after which the heating is switched off and the mixture left to cool down to room temperature. The reaction yields a dispersion which is then purified by, for example, dialysis.

The responsive nature of the particles is derived from the properties of a primary monomer or monomers such as poly (N-isopropylacrylamide). However, it is known that the incorporation of a co-monomer can influence the temperature or pH at which the particle undergoes a transition from a swollen to a collapsed state, or vice versa. For instance, Gao and Frisken (Gao J. and Frisken B. J, Langmuir, 2005, 21 (2), 545-551) have shown how incorporation of monomers such as styrene, methyl methacrylate and acrylic acid affect particle swelling and breadth of the phase transition. Tang et al (Ma X., Xi J., Zhao X. and Tang X., Journal of Polymer Science, Part B: Polymer Physics, (2005), 43(24), 3575-3583) investigated how the volume-phase transition temperature is affected by the incorporation of ethylene glycol containing monomers.

Polymeric compounds can be made in several forms. For example, hydrogels are water-swollen networks (cross-linked structures) of hydrophilic homopolymers or copolymers. They are three-dimensional and the cross-links can be formed by covalent or ionic bonds (“Preparation methods and structure of Hydrogels”, N. A. Peppas, A. G. Mikos, Hydrogels in medicine and pharmacy, Volume I Fundamentals, Ed. N. A. Peppas, Chapter 1, 1-25 (1985)).

Microgels as described by Baker (W. O. Baker, “Microgel, a new macromolecule”, Ind Eng Chem 41 (1949) 511-520) were defined as a new architecture for polymer particles that comprises cross-linked hydrophobic latex particles which swell in organic solvents to form colloidally dispersed gel particles. Over the last 20 years, interest has grown in hydrophilic microgels, i.e. cross-linked hydrophilic polymers, which swell in water. These microgels, as prepared in accordance with this invention, are intermediate between branched and macroscopically-cross-linked polymers and can best be described as (typically) having a narrow size distribution, and being spherical particles with average diameters from 50 nm to 5 μm (Current Opinions in Colloid and Interface Science, 13 (2008) 413-428).

The IUPAC definition of “latex” is an emulsion or sol in which each colloidal particle contains a number of macromolecules (Chapter 1, Les latex synthetiques, Lavoisier 2006). Practically, academic and industry scientists working in the field consider a synthetic latex to be a colloidal dispersion of particles composed of macromolecules, usually an aqueous dispersion. However, hydrophilic microgels are cross-linked polymers that have the capability to swell in water, which many latexes cannot do (being dispersed insoluble polymer particles). A particle composition comprising a dispersion of stimulus-responsive particles in a “solvent”, e.g. water, may be termed a microgel (an aqueous or hydrophilic microgel, as mentioned above, being capable of a swollen state in water). Such microgels have two states, one in which the solvent (e.g. water) is a good solvent under the conditions whereby the particles occupy a swollen state and another, in which the solvent is a poor solvent for the polymer under the conditions, whereby the polymer particles occupy a collapsed state. Typically, the particle composition switches between the two states when conditions change such that the conditions transition from poor solvent to good solvent conditions. In either state, a polymer particle composition capable of such a transition may be termed a microgel.

A problem with microgel compositions (e.g. aqueous or hydrophilic microgels) is that under high shear conditions, particularly in the collapsed state, they are particularly susceptible to aggregation which has a significant effect on the performance of these compositions.

In U.S. Pat. No. 5,306,593 Cunningham and Mahabadi describe a process for preparing polymer particles by starved-feed monomer addition, wherein the monomers, and optionally the cross-linking agents, are progressively added after the polymerization reaction has been initiated, to provide particles with high molecular weight and cross-linked domains. However the addition of a second monomer to reduce susceptibility to aggregation is not taught.

In U.S. Pat. No. 4,493,777 Snyder and Peters disclose aqueous fluids containing cross-linked microgel particles possessing superior lubricating and wear-resistant characteristics. Again the particles are not stimulus-responsive and in addition cross-linking is used only to control the degree of swellability in order to prevent particle wear. In U.S. Pat. No. 6,100,222 Vollmer et al. describe cross-linked, hydrophobic latex particles as being more stable under severe thermal shear conditions when printed through a thermal inkjet print head. However, no teaching is provided on the use of a second monomer to reduce aggregation.

WO 2008/075049 describes an aqueous inkjet ink composition comprising a colorant and a polymeric compound comprising discrete particles responsive to an external stimulus, the particles having a lower viscosity in a first rheological state and a higher viscosity in a second rheological state. The use of copolymers is disclosed but no teaching is disclosed on the use of the second monomer to reduce shear induced aggregation.

In Journal of Polymer Science: Part A Polymer Chemistry, 31, 963-969 (1993), Tam et al. describe the use of an anionic surfactant to increase the stability versus aggregation of a thermally-responsive linear polymer, poly (N-isopropylacrylamide), when the temperature is above its lower critical solution temperature. However, this stability is assessed only under very low shear rate.

### PROBLEM TO BE SOLVED BY THE INVENTION

Liquid-based formulations containing particles are used in many processes, for example as inks. In some applications, the formulations contain water-swellable, cross-linked polymers or “microgels”. In such applications formulations may be required to be pumped to pass through a filter or to pass along small channels in order, for example, to remove oversized particles by filtration or to generate and manipulate small volumes of liquid, for example for microfluidic applications, such as inkjet printing. The formulations are then subjected to a flow field that is characterized by high rates of shear and/or extension.

It is important for the success of the formulations in these applications that the microgel particles and other components are not aggregated as a consequence of experiencing the flow fields within the pump, the filter or the narrow channels. Low levels of aggregation would have effects on the rheology or product properties that are detrimental in that, for example, there could be phase separation; high levels of aggregation would serve to block the pump, filters or channels and so completely arrest the process.

### SUMMARY OF THE INVENTION

According to a first aspect of the invention, there is provided the use of a first stimulus-responsive polymer-forming monomer in combination with a further monomer to reduce the susceptibility to or decrease the extent of aggregation at high shear of a stimulus-responsive polymer-containing formulation by incorporating the further monomer into the stimulus-responsive polymer.

In a second aspect of the invention, there is provided use, in the preparation of a stimulus-responsive polymer particle composition comprising a first stimulus-responsive polymer-forming monomer, of a further monomer different from the first monomer to reduce the susceptibility to or decrease the extent of aggregation of a dispersion or formulation of the polymer particle composition at high shear by incorporating the second monomer into the polymer particle composition during formation of the polymer particles.

In a third aspect of the invention, there is provided a use of a formulation surfactant to render an aqueous formulation of a hydrophobic monomer-containing stimulus-responsive polymer particle less susceptible and/or resistant to aggregation at high shear, by incorporation of the formulation surfactant into the aqueous formulation in an amount of from 1 to 10 mMol/l.

In a fourth aspect of the invention, there is provided a method of minimizing, or reducing the susceptibility to, high-shear aggregation of a stimulus-responsive polymer particle composition by, during formation of the stimulus-responsive polymer particle composition comprising addition of a polymerization initiator to a reaction mixture containing first monomer(s) capable of forming a stimulus responsive polymer, the addition to the reaction mixture of an amount of a further monomer, said further monomer being different from said first monomer, prior to, during or at a time delayed from the initiation of the polymerization reaction of the first monomer, wherein the further monomer is capable of forming a polymer unresponsive to the stimulus.

In a fifth aspect of the invention, there is provided a method of making a polymeric particle composition comprising discrete particles responsive to an external stimulus, which polymeric particle composition in aqueous dispersion is resistant to aggregation in high-shear fields, which method comprises addition of a polymerization initiator to a reaction mixture comprising a first monomer corresponding to the responsive polymeric compound, wherein the method further comprises the addition to the reaction mixture of a further monomer in an amount of from 0.1 to 25 mol % relative to the first monomer before, during and/or after initiation of the polymerization reaction, wherein the further monomer corresponds to a polymer not responsive to said stimulus and/or the further monomer is more hydrophilic than the first monomer; and working up the reaction and dispersing the particle composition to produce an aqueous dispersion of polymer particles.

In a sixth aspect of the invention, there is provided a polymeric composition, comprising discrete polymeric particles responsive to an external stimulus, that is resistant to aggregation in high shear fields, the composition being obtainable by the above method.

In a seventh aspect of the invention, there is provided an inkjet ink composition comprising a polymeric compound as defined above.

### Advantageous Effect of the Invention

There are many processes in which liquid-based formulations containing particles are exposed to high-shear fields. However, it is usually vital to the working of those processes that particles do not aggregate in an uncontrolled fashion. The specific particles and particle compositions provided by this invention are largely immune to the effects of transient shear rates at least as high as 10⁶ s⁻¹, whilst maintaining their thermal responsiveness and being present at moderate concentration. In addition, the structural and chemical modifications brought about by the addition of a second monomer allow an improvement in stability in a high-shear field, even in the absence of a formulation additive such as a surfactant.

### BRIEF DESCRIPTION OF THE DRAWINGS

FIG. 1 represents the total monomer conversion mol % of N-isopropylacrylamide to poly(N-isopropylacrylamide) as a function of the reaction time in minutes.

FIG. 2 is a graph of hydrodynamic particle diameter in nm v. temperature of a stimulus-responsive particle (Curve A) and a latex polymer (Curve B).

FIG. 3 represents a diagram of the microfluidics device used to assess high-shear field stability of microgel dispersions, wherein A is the Sample Input, B is the pre-filter region, C is the Sample Measurement region, D is the Sample Output and E is an enlargement of C, wherein the arrows indicate the five, 10 μm gaps.

FIG. 4 represents the microfluidics device free of aggregation under testing conditions.

FIG. 5 represents the microfluidics device blocked with an aggregated comparative microgel suspension under testing conditions.

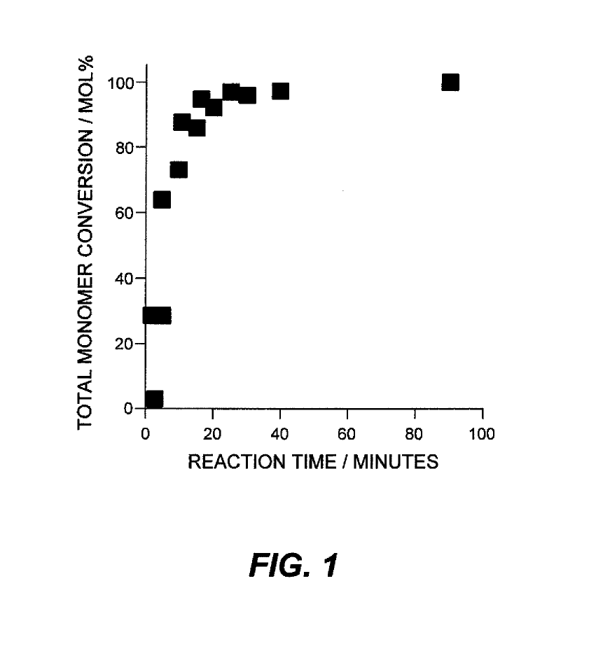

### DETAILED DESCRIPTION OF THE INVENTION

Aggregation is a phenomenon seen in many suspensions of relevance to industrial processes. Because this phenomenon can be extreme in nature, for example, the complete cessation of what may have been a free fluid flow, it is generally desirable to avoid such behaviour. The rheological manifestation is an abrupt rise in suspension viscosity as shear rate is increased, but this is so abrupt that it can be difficult to study using controlled shear-rate rheometers. As used herein and throughout the specification, high shear rate is defined as 10⁵ s⁻¹ or greater and low shear rates are defined as less than 10⁵ s⁻¹.

Moreover it can be difficult to reproduce the very high shear rate conditions generated in many practical applications and it is difficult to visualise exactly what is happening in a rheometer. In rotational rheometers it is difficult to obtain shear rates greater than 10⁵ s⁻¹. A microfluidic apparatus has a flow field similar to that in inkjet printers or that of a microfluidics disperser, the fluid moving relative to stationary walls rather than one wall moving and the other being at rest.

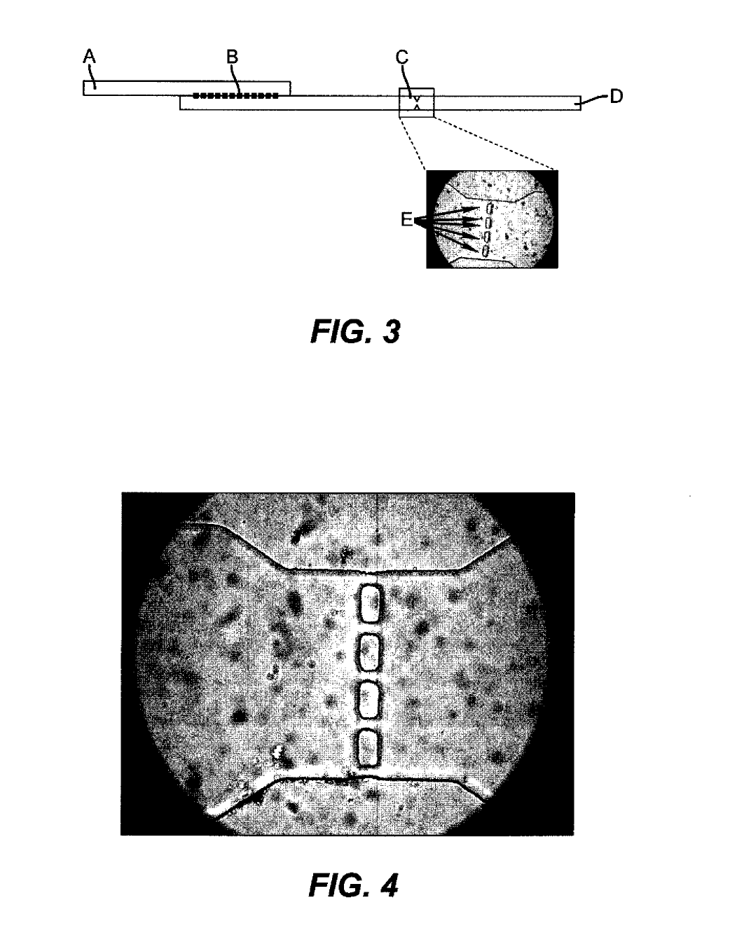

For these reasons, a microfluidic device made in polydimethyl-siloxane (PDMS) is used herein to create a fluid flow device to test for aggregation, as shown in FIG. 3, the device advantageously using only small quantities of material. The device has an input flow region A through a low-shear filter B, with an optional by-pass flow to enable flushing of the filter. A high-shear region C leads to the output flow D. The channels in the microfluidic device are about 40 μm in depth and about 200 μm in width, whereas the high-shear region C consists of a narrowing of the channel width to pass the fluid between a series of pillars defining one or more, and typically five, 10 μm gaps as shown in E. This arrangement provides a flow field in the high-shear region approximating to that found in the 12 μm nozzle of a continuous inkjet head, when pumped using a syringe pump at low flow rates.

All the examples were tested in the microfluidics device under the same range of high-shear field and as a consequence, their stabilities versus aggregation could be compared. Thus in accordance with the invention, suspensions of thermally-responsive polymeric particles, made by emulsion polymerization, could be exposed to varying shear conditions, producing shear rates, for example, from about 5×10⁵ s⁻¹ to 1.6×10⁶ s⁻¹ via adjustment of the flow rate, using the microfluidics device described above.

The shear rate may be estimated as (2Q)/(w.h.n.δ), wherein Q is the device flow rate, w the width of the channel, h the height of the channel, n the number of channels and δ the boundary layer thickness within the channel.

Thus screening could be made of suspensions resulting from variations in the synthesis of the polymeric particles and in particular variation in the amount and method of introducing the second monomer component to the reaction mixture, as well to the point at which that addition was made.

The present invention relates to stimulus-responsive polymer particles, particulates and dispersions, suspensions or formulations thereof in a carrier fluid (e.g. water), such as hydrophilic or aqueous microgels.

By aqueous composition, it is meant that the solvent or carrier fluid comprises water in an amount of at least 50% by weight, preferably at least 75%, more preferably at least 90% and still more preferably at least 98%. A purely aqueous composition comprises a carrier fluid consisting essentially of water.

The carrier-swellable stimulus-responsive polymer particulate material may be any suitable polymer composition which forms discrete particles in the carrier fluid (as opposed, for example, to a linear polymer material with significant multiple inter-polymer crosslinking) which polymer particulate material is compatible with the carrier fluid and preferably also other components of the printing composition. In the case of aqueous carrier, the carrier-swellable stimulus-responsive polymer particulate is a water-swellable stimulus-responsive polymer particulate.

By stimulus-responsive particles and particle composition (such as aqueous microgels) it is meant, preferably that the polymer particulate material or microgel particles are switchable whereby the carrier-swellability (e.g. water-swellability) is adjustable, due to some external change (switching function), between a first swollen (i.e. carrier retaining) state and a second unswollen (or collapsed) state. This first swollen (carrier-retaining) state may also be referred to as a “good solvent” regime, whereby conditions are such that the carrier is a good solvent for the polymer particles causing them to retain solvent and swell.

In response to an external stimulus, such as temperature change, the suspension of particles of the polymeric “microgels” may change from a first rheological state to a second rheological state. This change in rheological states of the suspension of stimulus-responsive particles equates to differences in size or shape or more particularly volume, represented by equivalent spherical diameter of the particles, the term equivalent spherical diameter being used in its art-recognized sense in recognition of particles that are not necessarily spherical.

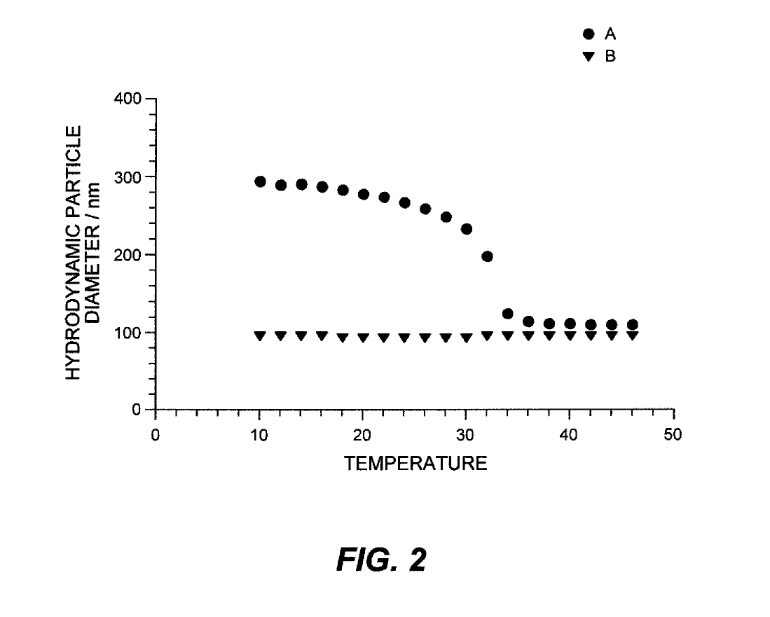

Thus, such microgel particle formulations are particularly useful in that when in a collapsed state the stimulus-responsive particles may have an equivalent spherical diameter considerably less than the diameter of the orifice or restriction they need to pass through (e.g. inkjet printhead), typically 2 μm or less, preferably 0.5 μm or less, more preferably 0.15 μm or less and especially 0.01 to 0.15 μm, for applications employing microfluidic or filtering processes. Lowering the temperature may cause an expansion of the stimulus-responsive particles as shown in curve A in FIG. 2 as compared to no volume change when a non stimulus-responsive latex polymer is used (see Curve B in FIG. 2). According to the desired application, the size and shape of the stimulus-responsive polymer particle may be adjusted during formation to be appropriate to the purpose for which it is required.

In the embodiments wherein the stimulus-responsive particles are thermally-responsive (i.e. the switching function is temperature), the temperatures at which switching occurs is referred to hereinafter as the “switching temperature”. The “switching temperature” can be fine-tuned to adapt to exterior conditions by appropriate selection of the stimulus-responsive polymer particles. Optionally, this can be done either by inclusion/exclusion of a co-monomer with appropriate hydrophilic or hydrophobic character in the main stimulus-responsive polymer fragment or by inclusion or adjustment of concentration of other components in the composition, such as a surfactant. However it is desirable that most of the volume change from a lower to a higher volume induced by the temperature change, and most of any change in properties, for example viscosity, occurs over as small a temperature range as possible.

The invention is also applicable to polymer particles which are responsive to other than temperature change such as, for example, changes in pH or light or an electrical or magnetic change or a combination thereof. The skilled person would readily appreciate alternative forms of enabling a significant change in response to a number of external stimuli to achieve the benefit of the present invention. In all cases it is desirable that the switching point from one rheological state to another occurs over as small as a range as possible.

The stimulus-responsive particles, especially thermally-sensitive polymers, may be prepared, for example, by polymerization of monomers which will impart thermal sensitivity, such as N-alkylacrylamides, such as N-ethyl-acrylamide and N-isopropylacrylamide, hereinafter NIPAM, N-alkyl-methacrylamides, such as N-ethylmethacrylamide and N-isopropyl-methacrylamide, vinylcaprolactam, vinyl methylethers, partially-substituted vinylalcohols, ethylene oxide-modified benzamide, N-acryloylpyrrolidone, N-acryloylpiperidine, N-vinylisobutyramide, hydroxyalkylacrylates, such as hydroxyethylacrylate, hydroxyalkylmethacrylates, such as hydroxyethyl-methacrylate, and copolymers thereof, by methods known in the art.

For instance, Varghese et al. (Journal Chemical Physics, 112, 6, 3063-3070, 2000) describe a thermally-sensitive co-polymer composed of a critical molar ratio of a highly hydrophilic co-monomer (2-acrylamido-2-methyl propane sulfonic acid) and a highly hydrophobic co-monomer (N-tertiary butylacrylamide), although neither of the homopolymers is thermally-sensitive.

Another class of thermally-sensitive polymers is composed of copolymers of 2-(2-methoxyethoxy)ethyl methacrylate and oligo(ethylene glycol) methacrylate, as described by Lutz et al. in Journal of the American Chemical Society, 2006, 13046-13047.

The thermally-sensitive polymer particles can also be prepared by micellization of stimulus-responsive polymers and cross-linked while in micelles. This method applies to such polymers as, for example, certain hydroxyalkyl-celluloses, aspartic acid, carrageenan and copolymers thereof.

Alternatively block copolymers of the stimulus-responsive particles may be created by incorporating one or more other unsubstituted or substituted polymer fragments such as, for example, polyacrylic acid, polylactic acid, polyalkylene oxides, such as polyethylene oxide and polypropylene oxide, polyacrylamides, polyacrylates, polyethyleneglycol methacrylate, polyvinyl alcohol, polyvinyl acetate, polyvinylpyrrolidone, polyvinyl chloride, polystyrene, polyalkyleneimines, such as polyethyleneimine, polyurethane, polyester, polyurea, polycarbonate or polyolefins. Introduction of a copolymer, such as a polyacrylic acid or polyethyleneglycol methacrylate, may be useful to fine-tune the switching temperature and swellablity.

Alternatively copolymers of stimulus-responsive particles may be created by incorporating one or more other unsubstituted or substituted co-monomers when the particle is synthesised. For example, acrylate or methacrylate derivatives, such as acrylic acid or 2-(methacryloyloxy)ethyl]dimethyl-3-sulfopropyl ammonium hydroxide or polyethylene glycol methacrylate, acrylamide, substituted acrylamide, such as dimethylacrylamide or 4-acryloylmorpholine or acrylamidomethyl propane sulfonic acid and salt derivatives thereof or [3-(methacryloylamino)propyl]dimethyl-3-sulfopropyl)ammonium hydroxide, and vinylic derivatives such as vinyl alcohol, vinyl benzene, vinyl amine, vinylacetic acid or 1-vinyl-2-pyrrolidinone, or other monomers with an unsaturated bond which can undergo addition polymerisation, such as fumaric acid, maleic acid and anhydride thereof, may be used. Other alkyl homologues of NIPAM can give higher or lower switching temperatures. Switching temperature is also known as LCST, that is lower critical solution temperature.

Any polymeric acidic groups present may be partially or wholly neutralized by an appropriate base, such as, for example, sodium or potassium hydroxide, ammonia solution, alkanolamines, such as methanolamine, dimethylethanolamine, triethylethanolamine or N-methylpropanolamine or alkylamines, such as triethylamine. Conversely, any amino groups present may be partially or wholly neutralized by appropriate acids, such as, for example, hydrochloric acid, nitric acid, sulfuric acid, acetic acid, propionic acid or citric acid. The copolymers may be random copolymers, block copolymers, comb copolymers, branched, star or dendritic copolymers.

The number of monomers units in the stimulus-responsive polymer particles may typically vary from about 20 to 1500 k. For example the number of monomer units in poly(NIPAM) is from 200-500 k and for poly-vinylcaprolactam is from 20 to 1500 k.

In accordance with the invention a further monomer is used to reduce the stimulus-responsive particle composition's or formulation's susceptibility to or degree of aggregation or to prevent aggregation in a high-shear field. Too high a concentration of the further monomer, however, may change the swellability of the particles in response to the stimulus to an undesirable degree. The quantity of the further monomer may influence the hydrophilicity or hydrophobicity or surface charge of the polymer particles and may adjust, for example, the swelling degree and/or phase transition temperature of the nonionic polymer. Accordingly, it is preferable that the amount of further monomer is such as to reduce the polymer particle composition or microgel composition's susceptibility to high-shear aggregation, whilst minimizing change to the phase transition temperature, in the case of thermally responsive particulate material (e.g. to less than 0.5° C.) and/or whilst minimizing any increase or decrease in swellability (to e.g. within 10%). In general, the total quantity of further monomer used with respect to the major type of the monomer (first monomer) should preferably be in the range of 0.1-25 mol %, more preferably from 0.5 or 1.0 to 20 mol %, most preferably 2.0-15 mol %, although not specifically limited thereto. The further monomer or monomers may added to the reaction mixture prior, during or after initiation of the polymerization reaction. For example, the further monomer(s) may be added prior to initiation of the polymerization, added drop by drop during a period within the first 90 minutes after initiation or in aliquots during a period within the first 90 minutes after initiation. As used herein and throughout the specification, the polymerization reaction is substantially complete when the reaction has progressed at least to 75% completion, more preferably at least to 85% completion, and most preferably to 90% completion.

Suitable further monomers for this purpose include, for example, any which become incorporated into the structure of the particle in such a way as to inhibit charge or hydrophobic interactions between particles in close contact either in the absence or presence of a surfactant. Examples of suitable further monomers include nonionic monomers such as polyethyleneglycol acrylate, polyethyleneglycol methacrylate, the methyl, ethyl, propyl and butyl ethers of polyethyleneglycol acrylates and methacrylates, N,N-dimethylacrylamide, 4-acryloylmorpholine, 2-hydroxyethylmethacrylate, 2-hydroxypropylmethacrylate and acrylamide. Suitable charged monomers include sodium 2-acrylamido-2-methyl-1-propane sulfonate, potassium 3-sulfopropyl acrylate, [3-(methacryloylamino)propyl]dimethyl(3-sulfopropyl)ammonium hydroxide, 2-(methacryloyloxy)ethyl]dimethyl-3-sulfopropyl ammonium hydroxide, acrylic acid, methacrylic acid, fumaric acid, maleic acid or anhydrides thereof and monoacryloxyethyl phosphate. Other more hydrophobic monomers can be used in combination with an anionic or non-ionic surfactant. These include styrene, butyl acrylate and tetrahydrofurfuryl acrylate.

Optionally, the stimulus-responsive polymer particle may be in the form of a core/shell particle wherein the polymer forms a shell that surrounds a core. The interaction with the core can be of a chemical nature such that the polymer would be grafted onto the surface of the core by bonds which are preferably covalent. However the interaction can be of a physical nature, for example the core can be encapsulated inside the switchable polymer shell, the stability of the core/shell assemblage being obtained by the cross-linking of the shell material. The core could be functionalized or non-functionalized polystyrene, latex, silica, titania, a hollow sphere, magnetic or conductive particles or could comprise an organic pigment. In the case of a core/shell particle, typically the equivalent spherical diameter of the core would be in the range of about 0.005-0.15 μm and the switchable shell grafted on to the surface of the core would be sufficient in the contracted state to provide a core/shell particle with such a diameter considerably less than the diameter of the orifice to prevent blockage and enable passage through an orifice or restriction as above. Thus the core/shell particle would have a particle equivalent diameter as stated above for a non-core/shell particle. Preferably, however, the particles are not core/shell particles of this type.

Examples of particular stimulus-responsive polymer particles according to the present invention include copolymers of N-alkylacrylamide (especially polyNIPAM) with, e.g. N—N-dimyethylacrylamide, 2-acrylamido-2-methyl-1-propane sulfonic acid and 4-acryloylmorpholine.

A polymerization reaction for the formation of stimulus-responsive particles according to the present invention may be initiated using a charged or chargeable initiator species, such as, for example, a salt of the persulfate anion, especially potassium persulfate, or with a neutral initiator species if a charged or chargeable co-monomer species is incorporated in the preparation. The initiation of the radical polymerization may then triggered by the decomposition of the initiatior resulting from exposure to heat or to light. In the case of initiation using heat, a reduced temperature can be used by combining the initiator compound, such as potassium persulfate, with an accelerator compound, such as sodium metabisulfite.

Surfactants or mixtures of surfactants may be used in the polymerization reaction for the synthesis of the stimulus-responsive microgel particles to control the size of the particles (synthesis surfactants). The surfactants may be anionic: for example, sodium dodecylsulfate, hereinafter SDS, salts of fatty acids, such as salts of dialkylsulfosuccinic acid, especially sodium dioctyl sulfosuccinate, hereinafter AOT, salts of alkyl and aryl sulfonates and salts of tri-chain amphiphilic compounds, such as sodium trialkyl sulfo-tricarballylates. The anionic surfactants may also comprise hydrophilic non-ionic functionalities, such as ethylene oxide or hydroxyl groups. They may be nonionic: for example, polyoxyethylene alkyl ethers, acetylene diols and their derivatives, alkylthiopolyacrylamides, copolymers of polyoxyethylene and polyoxypropylene, alcohol alkoxylates, sugar-based derivatives; they may be cationic, such as alkyl amines, quaternary ammonium salts; or they may be amphoteric: for example, betaines. However the surfactant should normally be selected such that it is either uncharged (non-ionic), has no overall charge (amphoteric or zwitterionic surfactant) or matches the charge of the stimulus-responsive polymer used. The preferred surfactants include acetylene diol derivatives, such as SURFYNOL 465 (available from Air Products Corp.) or alcohol ethoxylates such as TERGITOL 15-S-5 (available from Dow Chemical company), but the most preferred are SDS and AOT. The surfactants may be incorporated in the initial reaction mixture with a molar ratio up to 3 mol % of the total monomer amount, preferably 0.5 to 2.5 mol %, more preferably 0.7 to 1.5 mol %.

A crosslinker may be included in the preparation of the stimulus-responsive polymer particles to maintain the shape of the polymer particle, although too high a concentration of crosslinker may inhibit the swellability of the polymer. If there is an alternative way of maintaining particle architecture, such as a core particle in a polymer shell, it may be possible in some instances, however, to exclude a crosslinker.

Suitable cross-linkers for this purpose include, for example, any materials which will link functional groups between polymer chains and the skilled artisan would choose a crosslinker suitable for the materials being used e.g. via condensation chemistry. Examples of suitable cross-linkers include N,N′-methylenebisacrylamide, N,N′-ethylenebisacrylamide, dihydroxyethylene bisacrylamide, N,N′-bis-acryloylpiperazine, ethyleneglycol dimethacrylate, glycerin triacrylate, divinylbenzene, vinylsulfone or carbodiimides. The crosslinker may also be an oligomer with functional groups which can undergo condensation with appropriate functional groups on the polymer. The crosslinking material is used for partial crosslinking the polymer. The particles can also be crosslinked, for example, by heating or ionizing radiation, depending on the functional groups in the polymer.

The quantity of crosslinker used, if present, with respect to the major type of the monomer should normally be in the range of about 0.01-20 mol % of crosslinker to monomer, preferably 0.05 to 10 mol % of crosslinker to monomer, more preferably 0.05 to 7 mol % and more preferably 1 to 5 mol % of crosslinker to monomer although not specifically limited thereto. This is especially the case where the polymer formed comprises N-alkylacrylamide. The quantity of crosslinker will determine the crosslinking density of the polymer particles and may adjust, for example, the swelling degree and/or phase transition temperature, of the polymer.

In one embodiment of the invention, a crosslinker may be used in combination with a further monomer as defined above, to reduce the susceptibility of a stimulus-responsive polymer particle formulation (e.g. a hydrophilic microgel composition comprising, for example a polymer derived from NIPAM) to aggregation at high shear or to reduce the degree of aggregation or prevent such aggregation. Preferably, the crosslinker may be so used by the portion-wise addition of aliquots of said crosslinker to a reaction mixture comprising a stimulus-responsive polymer-forming monomer as herein defined, a further monomer as herein defined and a polymersiation initiator, an aliquot preferably being added after the polymerization has progressed substantially to completion.

Surfactants selected from those above, or mixtures of surfactants, may also be used as an additive in a composition or formulation containing stimulus-responsive microgel particles to improve stability versus aggregation (formulation surfactant). For this purpose the surfactant may preferably be incorporated in the composition with a concentration of up to 15 mmol/l, preferably 2 to 8 mmol/l.

Where a further monomer is a more hydrophobic monomer, such as styrene, butyl acrylate or tetrahydrofuryl acrylate, it has been surprisingly found that such monomers are capable of reducing the susceptibility of a water-swellable stimulus-responsive polymer particle aqueous composition (e.g. NIPAM-derived polymer particle compositions) to high-shear aggregation by incorporating such monomers in the polymer particles before or during polymerization and adding to the aqueous composition a formulation surfactant as referred to above.

The stimulus-responsive microgel particles can be used as components in many applications, for example, in inks, particularly in inkjet inks, for example, for “drop-on-demand” or “continuous” inkjet printing, in conventional printing inks, for example, for lithography, flexography, gravure or screen printing, in “inks” or “toners” for electrophotography, in fluids for microfluidic devices, in cosmetics, in medical applications, for example, for drug delivery, in photonic applications, or in any of the applications that capitalise on the responsive nature of the material and the property changes this brings.

There is further provided, therefore, a composition comprising a stimulus-responsive polymer particle composition and a functional material. Preferably, the composition comprises a suitable carrier for the stimulus-responsive polymer particle composition, e.g. the carrier may be water in order to form an aqueous microgel as defined herein.

A “functional material” is a material that provides a particular desired mechanical, electrical, magnetic or optical property. As used herein the term “functional material” preferably refers to a colorant, such as a pigment, which is dispersed in a carrier fluid, or a dye, dispersed and/or dissolved in the carrier fluid, magnetic particles (e.g. for barcoding), conducting or semi-conducting particles, quantum dots, metal oxide or wax. Preferably the functional material, however, is a pigment dispersed in the carrier fluid or a dye dispersed and/or dissolved in the carrier fluid.

Preferably, therefore, according to a further aspect of the present invention, there is provided a printing composition, which is preferably an aqueous inkjet printing ink, comprising an aqueous carrier fluid and a colourant, which may be a pigment or a dye, and which further comprises a water-swellable polymer particulate material according to the invention.

Optionally, the quantity of functional material, such as a colorant, namely pigment or dye, in an ink composition may be from about 0.5 wt % to about 50 wt %, more preferably from about 2 wt % to about 30 wt %.

The invention will now be described with reference to the following examples, which are however, in no way to be considered limiting thereof.

### EXAMPLES

The following examples illustrate methods of preparing polymeric particles wherein the addition of an additional monomer is varied in amount and at the point of addition as summarized in the following Tables. In each example the monomer, surfactant and cross-linking agent, when initially present, were added to a double-walled glass reactor equipped with a mechanical stirrer and condenser, the mixture was heated before addition of the polymerization initiator, with any further addition of the additional monomer where indicated. The N-isopropyl-acrylamide monomer, hereinafter NIPAM, the surfactant bis(2-ethylhexyl)-sulfosuccinate sodium salt (sodium dioctyl sulfosuccinate), hereinafter AOT, and the cross-linking agent methylenebisacrylamide, hereinafter BIS, were all obtainable from Sigma-Aldrich and the surfactant sodium dodecyl sulfate, hereinafter SDS, was obtainable from Fluka. Other monomers were obtained from Sigma-Aldrich, Fluka and Acros as required. In the following examples, the wt % of cross-linking agent is the weight ratio of the cross-linking agent to NIPAM monomer.

The particle size of the suspension of the thermally-sensitive particles was in each case measured by photon correlation spectroscopy, PCS, and determined with a Malvern ZetasizerNano ZS. A dilute sample of thermally-sensitive particles was obtained from the purified sample and was diluted with milli-Q water, a typical sample concentration being 0.05 wt %. Samples were equilibrated at each temperature for 10 minutes and then the size was measured 5 times, such that the total time at each temperature was approximately 25 minutes. The results quoted are the mean of the measurements. The volumetric swelling ratio is the cubic ratio between the hydrodynamic diameter measured at 20° C. and the hydrodynamic diameter measured at 50° C.

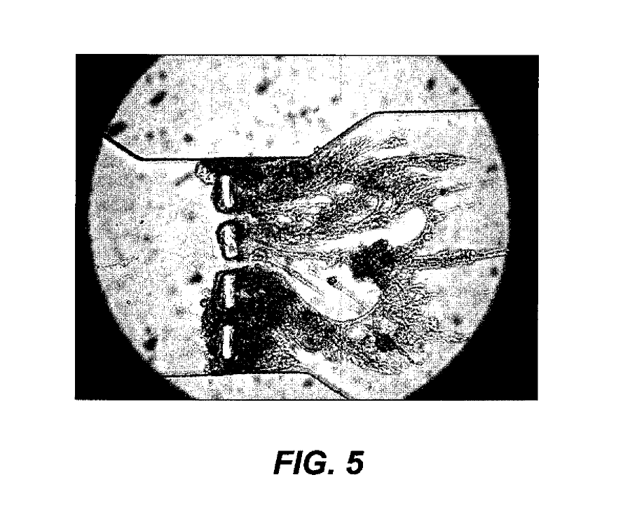

The stability versus aggregation under high-shear field was assessed by running a 4 wt % polymer dispersion with 4 mmol/l SDS, unless otherwise specified, in a microfluidics channel in a device as hereinbefore described and as shown in FIG. 3, with the high-shear region consisting of a narrowing of the channel width to pass the fluid between a series of pillars defining five 10 μm gaps. The typical flow rate was about 6 cm³/h (˜8×10⁵ s⁻¹). The sample was said not to aggregate when the channel remained free under a steady state (FIG. 4). The sample was said to aggregate when the channel was blocked when a steady state was reached (FIG. 5). The tests were performed at 50° C. in order to get sufficient fluidity for the dispersion.

When microgels particles were particularly stable under the above conditions and in the presence of 4 mmol/l SDS, the stabilizing surfactant was removed from the 4 wt % formulation polymeric dispersion and the extent of aggregation was compared for lower flow rates, typically 2 and 4 cm³/h.

### Comparative Example 1

### Poly(butylacrylate-co-methyl methacrylate) Latex Dispersion (C1)

REVACRYL 803 (Synthomer Ltd) is a butyl acrylate-co-methyl-methacrylate latex solution made of colloidal particles of a non water-swellable uncross-linked polymer. The particle size is 100 nm, as provided by the supplier. Test of a 4 wt % solution of latex in water did not show any aggregation in the microfluidics device, as shown in TABLE 1.

### Comparative Example 2

### Poly (N-isopropylacrylamide) (PNIPAM) Microgel; Sodium Dodecyl Sulfate (SDS) Surfactant; 2 wt % N,N-methylenebisacrylamide (BIS) (BIS/NIPAM Ratio) Added Only Before Addition of the Polymerization Initiator, Potassium Persulfate (C2)

This PNIPAM microgel was a water swellable cross-linked polymer prepared according to the method described in WO2008/075049A1, using SDS as a surfactant. 15.8 g N-isopropylacrylamide (NIPAM), 0.303 g BIS and 0.305 g SDS were added to a 1 L reactor. 900 ml water was added, the mixture warmed to 40° C. and purged with nitrogen for 30 minutes, while being stirred at 500 rpm. The solution was then heated to 70° C. and 0.602 g potassium persulfate initiator (dissolved in 20 ml deionized water which had been purged with nitrogen) was added quickly to the reactor. The mixture was stirred at 400 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 10 μS/cm.

Cross-linking agent/monomer molar ratio 0.014.
Particle hydrodynamic diameter 288 nm at 20° C.; 124 nm at 50° C.
Volumetric swelling ratio 12.5.

Test of a 4 wt % solution of PNIPAM “microgel” in water with 4 mmole/1 SDS, showed extensive aggregation in the microfluidics device, as shown in TABLE 1.

### Comparative Example 3

### PNIPAM Microgel; Sodium Dioctyl Sulfosuccinate (AOT) Surfactant; 2 wt % BIS Added (C3)

This PNIPAM microgel was a water swellable cross-linked polymer prepared using AOT as a surfactant. 79 g NIPAM, 1.5 g BIS and 4.5 g AOT were added to a 6 L reactor. 4400 ml milli Q water was added, the mixture warmed to 40° C. and purged with nitrogen for 1 h, while being stirred at 500 rpm. The solution was then heated to 70° C. and equilibrated for 90 minutes and 3 g potassium persulfate initiator (dissolved in 50 ml milli Q water which had been purged with nitrogen) was added quickly to the reactor. The mixture was stirred at 400 rpm at 70° C. for 6 h under nitrogen. The reaction mixture rapidly became opalescent, then white. The heating was switched off and the mixture left to cool to room temperature. The reaction yielded a transparent dispersion which was filtered, then dialyzed until the conductivity of the permeate was less than 10 μS/cm.

Cross-linking agent/monomer molar ratio 0.014.
Particle hydrodynamic diameter 137 nm at 20° C.; 59 nm at 50° C.
Volumetric swelling ratio 12.5.

Test of a 4 wt % solution of PNIPAM microgel in water with 4 mmol/l SDS, showed extensive aggregation in the microfluidics device, as shown in TABLE 2.

### Invention Example 1

### Modified PNIPAM Microgel: Prepared Using AOT Surfactant and 6.7 wt % (1.4 mol %) PEGMA Added After 15 Minutes (Inv. 1)

This modified PNIPAM microgel was prepared using the same molar composition of monomer to cross-linker and surfactant as the PNIPAM microgel described in Comparative Example 3, but 1.4 mol % of the NIPAM monomer was replaced by PEGMA monomer added in a single shot 15 minutes after the reaction had been initiated.

7.88 g NIPAM, 0.156 g BIS and 0.453 g AOT were added to a 1 L reactor. 450 ml water was added, the mixture warmed to 40° C. and purged with nitrogen for 30 minutes, while being stirred at 200 rpm. The solution was then heated to 70° C. and 0.308 g potassium persulfate initiator (dissolved in 10 ml deionized water which had been purged with nitrogen) was added quickly to the reactor. The reaction mixture rapidly became opalescent, then white. In a separate flask 0.624 g PEGMA was mixed with 10.22 ml of water and purged with argon for 1 minute. 15 minutes after the addition of the initiator solution was added, in one shot, 8.60 g of the PEGMA solution to the reactor. The mixture was then stirred at 200 rpm at 70° C. for a total of 6 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.0145.
Cross-linking agent/total monomer molar ratio 0.0143.
Particle hydrodynamic diameter 131 nm at 20° C.; 54 nm at 50° C.
Volumetric swelling ratio 14.3

Test of a 4 wt % solution of this PNIPAM microgel in water with 4 mmol/l SDS, did not show aggregation in the microfluidics device, as shown in TABLE 1.

### Invention Example 2

### Modified PNIPAM Microgel; SDS Surfactant; 15.4 wt % (15 mol %) N,N-dimethylacrylamide Added Before Addition of Polymerization Initiator (Inv. 2)

This modified PNIPAM microgel was prepared using the same composition as the PNIPAM microgel described in Comparative Examples 2, but 15 mol % of the NIPAM was replaced by N,N-dimethylacrylamide at the start of the reaction prior to initiation.

6.73 g NIPAM, 1.04 g N,N-dimethylacrylamide, 0.150 g BIS and 0.150 g SDS were added to a 1 L reactor. 450 ml water was added, the mixture warmed to 40° C. and purged with nitrogen for 30 minutes, while being stirred at 220 rpm. The solution was then heated to 70° C. and 0.225 g potassium persulfate initiator (dissolved in 10 ml deionized water which had been purged with nitrogen) was added quickly to the reactor. The reaction mixture rapidly became opalescent, then white. The mixture was then stirred at 220 rpm at 70° C. for 6 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.014.
Additional Monomer/NIPAM molar ratio 0.175
Particle hydrodynamic diameter 320 nm at 20° C.; 138 nm at 50° C.
Volumetric swelling ratio 12.5.

Test of a 4 wt % solution of this PNIPAM microgel in water with 4 mmol/l SDS, did not show aggregation in the microfluidics device, as shown in TABLE 1.

### Invention Example 3

### Modified PNIPAM Microgel; AOT Surfactant; 4.7 wt % (5.0 mol %) N,N-dimethylacrylamide Added Dropwise Over 15 Minutes After a Period of 40 Minutes had Elapsed Following Addition of Polymerization Initiator (Inv. 3)

This modified PNIPAM microgel was prepared using the same composition as the PNIPAM microgel described in Comparative Examples 3, but 5 mol % of the NIPAM was replaced by N,N-dimethylacrylamide added dropwise 40 minutes after initiation of the reaction.

7.50 g NIPAM, 0.150 g BIS and 0.225 g AOT were added to a 1 L reactor. 430 ml water was added, the mixture warmed to 40° C. and purged with nitrogen for 30 minutes, while being stirred at 220 rpm. The solution was then heated to 70° C. and 0.300 g potassium persulfate initiator (dissolved in 10 ml deionized water which had been purged with nitrogen) was added quickly to the reactor. The reaction mixture rapidly became opalescent, then white. After 40 minutes 0.349 g N,N-dimethylacrylamide was added dropwise from a pressure equalizing funnel over 15 minutes to the stirred reaction. The mixture was then stirred at 220 rpm at 70° C. for 61 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.0146.
Additional Monomer/NIPAM molar ratio 0.053
Particle hydrodynamic diameter 168 nm at 20° C.; 72 nm at 50° C.
Volumetric swelling ratio 12.7.

Test of a 4 wt % solution of this PNIPAM microgel in water with 4 mmol/l SDS, showed only very minor aggregation in the microfluidics device, as shown in TABLE 1.

### Invention Example 4

### Modified PNIPAM Microgel; AOT Surfactant; 10.0 wt % (11.2 mol %) N,N-dimethylacrylamide Added Dropwise Over 47 Minutes After a Period of 40 Minutes had Elapsed Following Addition of Polymerization Initiator (Inv. 4)

This modified PNIPAM microgel was prepared using the same composition as the PNIPAM microgel described in Comparative Examples 3, but 11.2 mol % of the NIPAM was replaced by N,N-dimethylacrylamide added slowly dropwise 40 minutes after initiation of the reaction.

7.11 g NIPAM, 0.150 g BIS and 0.225 g AOT were added to a 1 L reactor. 400 ml water was added, the mixture warmed to 40° C. and purged with nitrogen for 30 minutes, while being stirred at 220 rpm. The solution was then heated to 70° C. and 0.300 g potassium persulfate initiator (dissolved in 10 ml deionized water which had been purged with nitrogen) was added quickly to the reactor. The reaction mixture rapidly became opalescent, then white. After 40 minutes 0.79 g N,N-dimethylacrylamide dissolved in 40 ml water and previously purged with nitrogen was added dropwise from a pressure equalizing funnel over 47 minutes to the stirred reaction. The mixture was then stirred at 220 rpm at 70° C. for 6 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.0154.
Additional Monomer/NIPAM molar ratio 0.126
Particle hydrodynamic diameter 136 nm at 20° C.; 63 nm at 50° C.
Volumetric swelling ratio 10.1.

Test of a 4 wt % solution of this PNIPAM microgel in water with 4 mmol/l SDS, showed only very minor aggregation in the microfluidics device, as shown in TABLE 1.

### Invention Example 5

### Modified PNIPAM Microgel; AOT Surfactant; 2-acrylamido-2-methyl-1-Propane Sulfonic Acid, Sodium Salt (AMPS) (Inv. 5)

This modified PNIPAM microgel was prepared using the same composition as the PNIPAM microgel described in Comparative Example 3, but 10 wt % (4.7 mol %) 2-acrylamido-2-methyl-1-propane sulfonic acid, sodium salt (AMPS) was present in the reactor prior to the reaction initiation.

8.88 g NIPAM, 1.896 g AMPS as a 50% solution in water, 0.169 g BIS and 0.505 g AOT were added to a 1 L reactor. 490 ml milli Q water was added, the mixture warmed to 40° C. and purged with nitrogen for 45 minutes, while being stirred at 250 rpm. The solution was then heated to 70° C. and equilibrated for 30 minutes. 0.337 g potassium persulfate initiator (dissolved in 10 ml milli Q water which had been purged with nitrogen for 2 min) was added quickly to the reactor. The reaction mixture rapidly became opalescent, then bluish white. The mixture was then stirred at 400 rpm at 70° C. for 6 hr. under nitrogen. The heating was switched off and the mixture left to cool to room temperature. The reaction yielded a slightly turbid dispersion which was filtered, then dialyzed until the conductivity of the permeate was less than 10 μS/cm.

Cross-linking agent/NIPAM molar ratio 0.014.
AMPS/NIPAM molar ratio 0.047
Particle hydrodynamic diameter 118 nm at 20° C.; 58 nm at 50° C.
Volumetric swelling ratio of 8.4.

Test of a 4 wt % solution of this PNIPAM microgel in water with 4 mmol/l SDS, did not show aggregation in the microfluidics device, as shown in TABLE 1.

### Invention Example 6

### Modified PNIPAM Microgel; AOT Surfactant; 12.5 wt % (9.0 mol %) 4-acryloylmorpholine Added Before Addition of Polymerization Initiator (Inv. 6)

This modified PNIPAM microgel was prepared using the same composition as the PNIPAM microgel described in Comparative Examples 3, but 9.0 mol % of the NIPAM was replaced by 4-acryloylmorpholine at the start of the reaction prior to initiation.

7.52 g NIPAM, 0.93 g 4-acryloylmorpholine, 0.163 g BIS and 0.290 g AOT were added to a 1 L reactor. 440 ml water was added, the mixture warmed to 40° C. and purged with nitrogen for 30 minutes, while being stirred at 220 rpm. The solution was then heated to 70° C. and 0.302 g potassium persulfate initiator (dissolved in 10 ml deionized water which had been purged with nitrogen) was added quickly to the reactor. The reaction mixture rapidly became opalescent, then white. The mixture was then stirred at 220 rpm at 70° C. for 6 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.016.
Additional Monomer/NIPAM molar ratio 0.100

Test of a 4 wt % solution of this PNIPAM microgel in water with 4 mmol/l SDS, showed only very minor aggregation in the microfluidics device, as shown in TABLE 1.

### Invention Example 7

### Modified PNIPAM Microgel; AOT Surfactant; 4.8 wt % (5.0 mol %) Styrene Added Before Addition of Polymerization Initiator (Inv. 7)

This modified PNIPAM microgel was prepared using the same composition as the PNIPAM microgel described in Comparative Examples 3, but 5.0 mol % of the NIPAM was replaced by styrene at the start of the reaction prior to initiation.

7.69 g NIPAM, 407 μl styrene, 0.151 g BIS and 0.451 g AOT were added to a 1 L reactor. 450 ml water was added, the mixture warmed to 40° C. and purged with nitrogen for 30 minutes, while being stirred at 200 rpm. The solution was then heated to 70° C. and 0.307 g potassium persulfate initiator (dissolved in 10 ml deionized water which had been purged with nitrogen) was added quickly to the reactor. The reaction mixture rapidly became opalescent, then bluish white. The mixture was then stirred at 220 rpm at 70° C. for 6 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.014.
Additional Monomer/NIPAM molar ratio 0.050
Particle hydrodynamic diameter 140 nm at 20° C.; 56 nm at 50° C.
Volumetric swelling ratio 15.6.

Test of a 4 wt % solution of this PNIPAM microgel in water with 4 mmol/l SDS, showed only minor aggregation in the microfluidics device, as shown in TABLE 1.

### Invention Example 8

### Modified PNIPAM Microgel; AOT Surfactant; 4.8 wt % (5.0 mol %) Styrene Added 30 Minutes After Addition of Polymerization Initiator (Inv. 8)

This modified PNIPAM microgel was prepared using the same composition as the PNIPAM microgel described in Comparative Examples 3, but 5.0 mol % of the NIPAM was replaced by styrene added 30 minutes after initiation of the polymerization.

7.70 g NIPAM, 0.154 g BIS and 0.455 g AOT were added to a 1 L reactor. 450 ml water was added, the mixture warmed to 40° C. and purged with nitrogen for 30 minutes, while being stirred at 200 rpm. The solution was then heated to 70° C. and 0.309 g potassium persulfate initiator (dissolved in 10 ml deionized water which had been purged with nitrogen) was added quickly to the reactor. The reaction mixture rapidly became opalescent, then bluish white. After 30 minutes 407 μl styrene was added from a micropipette. The mixture was then stirred at 220 rpm at 70° C. for 6 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.014.
Additional Monomer/NIPAM molar ratio 0.050
Particle hydrodynamic diameter 140 nm at 20° C.; 60 nm at 50° C.
Volumetric swelling ratio 12.4.

Test of a 4 wt % solution of this PNIPAM microgel in water with 4 mmol/l SDS, showed only very minor aggregation in the microfluidics device, as shown in TABLE 1.

### Invention Example 9

### Modified PNIPAM Microgel; AOT Surfactant; 5.9 wt % (5.0 mol %) Butyl Acrylate Added 30 Minutes After Addition of Polymerization Initiator (Inv. 9)

This modified PNIPAM microgel was prepared using the same composition as the PNIPAM microgel described in Comparative Examples 3, but 5.0 mol % of the NIPAM was replaced by butyl acrylate added 30 minutes after initiation of the polymerization.

7.67 g NIPAM, 0.150 g BIS and 0.456 g AOT were added to a 1 L reactor. 450 ml water was added, the mixture warmed to 40° C. and purged with nitrogen for 30 minutes, while being stirred at 200 rpm. The solution was then heated to 70° C. and 0.307 g potassium persulfate initiator (dissolved in 10 ml deionized water which had been purged with nitrogen) was added quickly to the reactor. The reaction mixture rapidly became opalescent, then bluish white. After 30 minutes 507 μl butyl acrylate was added from a micropipette. The mixture was then stirred at 220 rpm at 70° C. for 6 hr under nitrogen. The heating was switched off and the mixture left to cool to room temperature. The reaction yielded a white dispersion which was filtered, then dialyzed until the conductivity of the permeate was less than 10 μS/cm.

Cross-linking agent/NIPAM molar ratio 0.014.
Additional Monomer/NIPAM molar ratio 0.050
Particle hydrodynamic diameter 140 nm at 20° C.; 63 nm at 50° C.
Volumetric swelling ratio 11.0.

Test of a 4 wt % solution of this PNIPAM microgel in water with 4 mmol/l SDS, showed only minor aggregation in the microfluidics device, as shown in TABLE 1.

TABLE 1

| | | | Particle | Additional | Additional | |
|---|---|---|---|---|---|---|
| | | | Diameter | Monomer added | Monomer | |
| | | Particle | (nm) at | prior to | after | |
| Example | Example type | type | 50° C. | Initiation? | Initiation? | Aggregation? |
| C1 | Comparative | Hard-sphere | 100 | None | None | None |
| | | latex | | | | |
| C2 | Comparative | Microgel | 124 | None | None | Severe |
| C3 | Comparative | Microgel | 59 | None | None | Severe |
| Inv. 1 | Inventive | Microgel | 54 | None | 6.7 mol % | None |
| | | | | | added after | |
| | | | | | 15 minutes | |
| Inv. 2 | Inventive | Microgel | 138 | 15.0 mol % | None | None |
| Inv. 3 | Inventive | Microgel | 72 | None | 5.0 mol % | Very Minor |
| | | | | | added after | |
| | | | | | 40 minutes | |
| Inv. 4 | Inventive | Microgel | 63 | None | 11.2 mol % | Very Minor |
| | | | | | added after | |
| | | | | | 40 minutes | |
| Inv. 5 | Inventive | Microgel | 58 | 4.7 mol % | None | None |
| Inv. 6 | Inventive | Microgel | — | 9.0 mol % | None | Very Minor |
| Inv. 7 | Inventive | Microgel | 56 | 5.0 mol % | None | Minor |
| Inv. 8 | Inventive | Microgel | 60 | None | 5.0 mol % | Very Minor |
| | | | | | added after | |
| | | | | | 30 minutes | |
| Inv. 9 | Inventive | Microgel | 63 | None | 5.0 mol % | Minor |
| | | | | | added after | |
| | | | | | 30 minutes | |

PNIPAM microgels prepared in the presence of either SDS (Comparative Example 2) or AOT (Comparative Example 3) exhibited aggregation under high-shear field although their sizes differ. The delayed addition of the non-ionic, hydrophilic polyethyleneglycol methacrylate monomer (Inventive Example 1) gave rise to microgels that do not aggregate under the high shear conditions of the microfluidics test. Addition of the non-ionic, less hydrophilic N,N-dimethylacrylamide monomer (Inventive Example 2) also produced microgels that do not aggregate under the test conditions. Delayed addition of the N,N-dimethylacrylamide monomer (Inventive Examples 3 and 4) produces microgels that suffer from only a very minor degree of aggregation. Addition of the anionic, hydrophilic sodium 2-acrylamido-2-methyl-1-propane sulfonate monomer (Inventive Example 5) successfully eliminates aggregation in the high shear device. Introduction of the non-ionic 4-acryloylmorpholine monomer (Example 6) is somewhat less effective than N,N-dimethylacrylamide but also reduces aggregation.

Hydrophobic monomers such as styrene (Inventive Examples 7 and 8) and butyl acrylate (Inventive Example 9) do not reduce aggregation when used alone but unexpectedly reduce aggregation in the presence of surfactants such as SDS.

1. A method of minimizing, or reducing the susceptibility to, high-shear aggregation of a dispersion or formulation of a stimulus-responsive polymer particle composition, comprising, during formation of the stimulus-responsive polymer particle composition, addition of a polymerization initiator to a reaction mixture containing first monomer(s) capable of forming a stimulus responsive polymer, and addition to the reaction mixture of an amount of a further monomer, said further monomer being different from said first monomer, prior to, during or at a time delayed from the initiation of the polymerization reaction of the first monomer, wherein the further monomer is capable of forming a polymer unresponsive to the stimulus.

2. A method as claimed in claim 1, wherein the stimulus-responsive polymer-particle composition is an aqueous microgel.

3. A method as claimed in claim 1, wherein the further monomer is any monomer which can be incorporated into the structure of the polymer particle in such a way as to inhibit charge or hydrophobic interactions between polymer particles in a polymer particle-containing formulation.

4. A method as claimed in claim 1, wherein the further monomer is hydrophobic and the formulation comprises a formulation surfactant.

5. A method as claimed in claim 4, wherein the further monomer comprises one or a combination of two or more of styrene, butyl acrylate, and tetrahydrofuryl acrylate.

6. A method as claimed in claim 5, wherein the formulation surfactant is sodium dodecyl sulfate.

7. A method as claimed in claim 1, wherein the further monomer is hydrophilic.

8. A method as claimed in claim 7, wherein the further monomer is one or a combination of two or more of polyethyleneglycol acrylate, polyethyleneglycol methacrylate, the methyl, ethyl, propyl and butyl ethers of polyethyleneglycol acrylates and methacrylates, N,N-dimethylacrylamide, 4-acryloylmorpholine, 2-hydroxyethylmethacrylate, 2-hydroxypropylmethacrylate, acrylamide, sodium 2-acrylamido-2-methyl-1-propane sulfonate, potassium 3-sulfopropyl acrylate, [3-(methacryloylamino)propyl]dimethyl(3-sulfopropyl)ammonium hydroxide, 2-(methacryloyloxy)ethyl]dimethyl-3-sulfopropyl ammonium hydroxide, acrylic acid, methacrylic acid, fumaric acid, maleic acid or anhydrides thereof and monoacryloxyethyl phosphate.

9. A method as claimed claim 1, wherein the first monomer is selected from one or more of: N-alkylacrylamides, N-alkyl-methacrylamides, vinylcaprolactam; vinyl methylethers; partially-substituted vinylalcohols; ethylene oxide-modified benzamide; N-acryloylpyrrolidone; N-acryloylpiperidin; N-vinylisobutyramide; hydroxyalkylacrylates, and hydroxyalkylmethacrylates.

10. A method as claimed in claim 1, wherein the first monomer is selected from one or more of: N-ethyl-acrylamide, N-isopropylacrylamide; N-ethylmethacrylamide, and N-isopropyl-methacrylamide.

11. A method as claimed in claim 10, wherein the first monomer is N-isopropylacrylamide.

12. A method as claimed in claim 1, wherein the first monomer is an N-alkylacrylamide and the further monomer is selected from one or more of N—N-dimethylacrylamide, 2-acrylamido-2-methyl-1-propane sulfonic acid and 4-acryloylmorpholine.

13. A method as claimed in claim 12, wherein the first monomer is N-isopropylacrylamide.

14. A method as claimed in claim 1, wherein the further monomer is present in an amount of from 0.1 to 25 mol % of the first monomer.

15. A method as claimed in claim 1, wherein the further monomer is present in an amount of from 2 to 15 mol % of the first monomer.

16. A method as claimed in claim 1, wherein the stimulus responsive particles are responsive to an external stimulus selected from change in temperature, pH, light, redox potential, electrical field, magnetic field or combinations thereof.

17. A method as claimed in claim 16, wherein the external stimulus is change in temperature.

18. A method of making a polymeric particle composition comprising discrete particles responsive to an external stimulus, which polymeric particle composition in aqueous dispersion is resistant to aggregation in high-shear fields, which method comprises addition of a polymerization initiator to a reaction mixture comprising a first monomer corresponding to the responsive polymeric compound, wherein the method further comprises the addition to the reaction mixture of a further monomer in an amount of from 0.1 to 25 mol % relative to the first monomer before, during and/or after initiation of the polymerization reaction, wherein the further monomer corresponds to a polymer not responsive to said stimulus and/or the further monomer is more hydrophilic than the first monomer; and working up the reaction and dispersing the particle composition to produce an aqueous dispersion of polymer particles.

19. A polymeric particle composition comprising discrete polymeric particles responsive to an external stimulus, that is resistant to aggregation in high shear fields, obtained by a method according to claim 18.

20. An inkjet ink comprising a polymeric particle composition as claimed in claim 19.
